(19) United States
(12) Patent Application Publication
(10) Pub. No.: US 2008/0179299 A1
(43) Pub. Date: Jul. 31, 2008

(54) SOLDERING NOZZLE AND APPARATUS USING THE SAME

(75) Inventors: Hiroshi FUKAYA, Shatin (HK); Satoshi YAMAGUCHI, Shatin (HK)

Correspondence Address: GREENBLUM & BERNSTEIN, P.L.C., 1950 ROLAND CLARKE PLACE, RESTON, VA, 20191, US

(73) Assignee: SAE MAGNETICS (H.K.) LTD., Hong Kong (HK)

(21) Appl. No.: 12/021,558

(22) Filed: Jan. 29, 2008

(30) Foreign Application Priority Data
Jan. 30, 2007 (JP) 2007-020142

(51) Int. Cl. B23K 26/20

(52) U.S. Cl. 219/121.63

(57) ABSTRACT

To improve the reliability of soldering so as to improve the quality of the products manufactured thereby. Provided is a solder nozzle having a heating beam irradiation hole formed therein for irradiating a heating beam to a solder ball placed between each of bonding pads formed in respective bonding targets. The solder nozzle comprises, in an area that is closer to its tip side than a heating beam output end part of the heating beam irradiation hole, a shift restricting device for restricting shift of the solder ball, to which the heating beam is irradiated, at least in two directions that are orthogonal to each other.

### BACKGROUND OF THE INVENTION

1. Field of the Invention

The present invention relates to a soldering nozzle and, more specifically, to a soldering nozzle which performs soldering by irradiating a heating beam to a solder ball.

2. Description of the Related Art

Soldering is employed in many cases as a method for bonding electronic components to substrates. By employing soldering, it is possible to fix an electronic component to a substrate and to electrically connect a terminal formed in the electronic component with a terminal formed on the substrate at the same time. For example, as will be described later, it can be employed for soldering a magnetic head slider (an electronic component) to a suspension (flexure) to which a flexible printed board is unified, when manufacturing a head gimbals assembly that is loaded on a magnetic disk device. FIG. 1-FIG. 8 show a soldering apparatus and a state at the time of soldering a magnetic head slider. Specifically, soldering of a magnetic head slider 302 is performed by placing a slider-side pad 322 formed in a magnetic head element 321 of the magnetic head slider 302 and a suspension-side pad 314 formed on a flexible printed board 313 to form right angles with each other, and by solder-bonding the pads 322 and 314 to each other. There are six each of the pads 322 and 314 formed therein in pairs (see a head gimbals assembly shown in FIG. 10 to be described later).

As shown in FIG. 1, first, the soldering apparatus comprises a support stand W (bonding target placing device) for supporting a flexure 312 that constitutes a suspension to which a trace 313 is unified. Further, the soldering apparatus comprises a transporting nozzle 304 which holds, at its tip part (the lower part in FIG. 1), the magnetic head slider 302 that is bonded onto a tongue part of the flexure 312, and transports and places it at a bonding position on the flexure 312. A driver 306 is connected to the transporting nozzle 304 to control the position of the transporting nozzle, so that the transporting nozzle 304 can transport the magnetic held slider 302 held at its tip part. Further, a suction device 307 is connected to the transporting nozzle 304, and the tip part of the transporting nozzle 304 is formed substantially in a cylindrical shape. A sucking force is generated by sucking the air from the tip side (lower end side) towards the inner side (upper side). The transporting nozzle 304 holds the magnetic head slider 302 at its tip part by sucking the magnetic head slider 302 towards the upper side by the sucking force.

Further, the soldering apparatus comprises: a laser nozzle 305 from which a laser beam for heating a solder ball 303 at a solder bonding point; and a laser irradiator 308 for outputting the laser beam from the laser nozzle 305. The laser nozzle 305 is structured to be capable of holding the solder ball 303 at its tip part by suction. Therefore, it is possible to irradiate the laser beam to the solder ball 303 while holding the solder ball 303 at the tip part of the nozzle 305 and placing the solder ball 303 at the solder bonding point that is between the slider-side pad 322 and the suspension-side pad 314. Further, the soldering apparatus comprises a control unit 309 which controls actions of the entire apparatus, i.e. actions of the driver 306, the suction device 307, and the laser irradiator 308 described above.

By controlling the actions of the apparatus with the above-described control unit 309, first, the magnetic head slider 302 having the magnetic head element 321 is sucked and held at the transporting nozzle 304, and the transporting nozzle 304 is moved to place the magnetic head slider 302 at a bonding position on the flexible printed board that is formed as one body on the flexure 312. Thereafter, the laser nozzle 305 having the solder ball 303 sucked and held at its tip part is moved to place the solder ball 303 to be abutted against the slider-side pad 322 and the suspension-side pad 314, which are to be solder-bonded. In this state, a laser beam is irradiated to the solder ball 303 from the laser nozzle 305. With this, the solder ball 303 is fused, thereby making it possible to solder-bond the pads 322 and 314 to each other.

Now, the structure of the laser nozzle 305 that irradiates a laser beam to the solder ball 303 will be described in detail by referring to FIG. 2-FIG. 6. FIG. 2 is a perspective view of the tip part of the laser nozzle 305 when viewed from the tip side, and FIG. 3 is an illustration showing the state where the solder ball 303 is loaded to the laser nozzle 305. Further, FIG. 4 is an illustration of the laser nozzle 305 when viewed from the side, and FIG. 5 is an illustration when viewed from the tip side. FIG. 6 is a sectional view of the laser nozzle 305 taken along the line B-B of FIG. 5.

As shown in those illustrations, first, the laser nozzle 305 is formed in a mountain-like shape (wedged shape) having a prescribed-width sharp tip part, which is formed with two inclined plane meeting at a right angle. The ridgeline part that is the tip part is chamfered (see FIG. 2 and FIG. 6). Further, six solder recessed parts 351 corresponding to six solder-bonding points between each of the pads are formed in the chamfered part along the ridgeline (see FIG. 2 and FIG. 5). As shown in FIG. 4, the solder recessed parts 351 are formed by drilling through the inclined planes from the side, and the solder ball 303 can be housed in each recessed part as shown in FIG. 3. Further, tubular laser irradiation holes 352, 353, through which the laser beams outputted from the above-described laser irradiator 308 are guided, is formed in the inner bottom face of the solder recessed part 351. Regarding the sectional view of the laser irradiation holes 352, 353, as can be seen from FIG. 5 and FIG. 6, those holes are constituted with a circular center hole 352 that is smaller than the diameter of the solder ball 303 and two semicircular extended holes 353 formed in the periphery of the center circle on each inclined plane side.

Subsequently, the state of soldering in a case of using the laser nozzle 305 with the above-described shape will be described by referring to FIG. 7-FIG. 8. First, as shown in FIG. 7, the solder ball 303 is supplied between the bonding pad 322 (slider-side pad) of the magnetic head slider 302 and the bonding pad 314 (suspension-side pad) of the flexible printed board 313, which are arranged substantially at a right angle, and the tip part of the laser nozzle 305 is brought to be near or to be in contact with the solder ball 303. At this time, a part of the solder ball 303 is housed in the tip part of the laser nozzle 305, i.e. in the above-described solder recessed part 351. Specifically, the laser nozzle 305 is connected to a suction device (not shown), thereby making it possible to hold the solder ball 303 at its tip part by suction. While holding the solder ball 303 at the tip end thereof, the nozzle 305 supplies the solder ball 303 to the solder bonding point.

Then, when laser beams are irradiated from the laser nozzle 305 under the state of FIG. 7, a laser beam L301 outputted from the center hole 352 part of the laser irradiation holes is irradiated to the solder ball 303, and laser beams L302, L303 irradiated form the extended hole parts 353 are irradiated to the vicinity of the circumference of the solder ball 303. The laser beams L302 and L303 outputted from the extended hole 353 parts pass around the circumference of the solder ball 303, which are irradiated to each of the pads 322 and 314 as well. At this time, laser gasses outputted along with the laser beams L302 and L303 also pass around the circumference of the solder ball 303 and travel to circle around the circumference. Thus, as shown in FIG. 8, it is possible to suppress, to some extent, shift of the solder ball 303 in directions of arrows, i.e. in a direction almost perpendicular to the arranged array direction of the solder recessed parts 351 (ridgeline direction) that is shown with the arrows in FIG. 3. The shift of the solder ball 303 in the arranged array direction of the solder recessed parts 351 can be suppressed to some extent by wall faces between each of the solder recessed parts 351.

### Patent Document 1: Japanese Unexamined Patent Publication 2005-123581

However, the above-described laser nozzle 305 in such shape restricts the position of the solder ball 303 only by the passage of the laser gasses, so that the position control performed thereby is still unstable. Further, the wall faces are the level faces, so that it is unstable to restrict the position of the solder ball 303 in a spherical body in the arranged array direction of the solder recessed parts 351. Therefore, it is difficult to locate the solder ball 303 with high precision at the time of soldering, which may result in deteriorating the reliability of soldering for both of the bonding pads 322 and 314.

### SUMMARY OF THE INVENTION

The object of the present invention therefore is to improve the inconveniences of the conventional case described above and, more specifically, to improve the reliability of soldering so as to improve the quality of the products manufactured thereby.

A solder nozzle according to one aspect of the present invention is a solder nozzle having a heating beam irradiation hole formed therein for irradiating a heating beam to a solder ball placed between each of bonding pads formed in respective bonding targets. The solder nozzle comprises, in an area that is closer to its tip side than a heating beam output end part of the heating beam irradiation hole, a shift restricting device for restricting shift of the solder ball, to which the heating beam is irradiated, at least in two directions that are orthogonal to each other.

Further, a solder nozzle according to another aspect of the present invention is a solder nozzle having a plurality of heating beam irradiation holes formed therein in an array for irradiating heating beams, respectively, to a plurality of solder balls placed between each of bonding pads formed in respective bonding targets. The solder nozzle comprises, in an area that is closer to its tip side than a heating beam output end part of each of the heating beam irradiation holes, a shift restricting device for restricting shift of the solder ball, at least in an arranged direction of the plurality of heating beam irradiation holes and in a direction perpendicular to the arranged array direction.

With the present invention described above, shift of the solder ball at the time of soldering can be suppressed by the shift restricting device provided in the area that is closer to the tip side than the output end part of the solder nozzle. Thus, the solder ball can be located at the solder bonding point with high precision at the time of soldering, thereby making it possible to improve the reliability of soldering.

Further, the solder nozzle employs such a structure that: a recessed part having a wider cross section than that of the laser irradiation hole, which is capable of housing a part of the solder ball, is formed in an area that is closer to its tip side than a heating beam output end part; and the shift restricting device is formed with inner wall faces of the recessed part.

Thereby, the recessed part having a still wider cross section is formed in the tip part of the laser irradiation hole, and a part of the solder ball is housed in the recessed part at the time of soldering. With this, shift of the solder ball can be restricted by the inner wall faces of the recessed part. Therefore, it becomes possible to control positioning of the solder with a simple structure, thereby making it possible to improve the reliability of soldering still further.

Further, the solder nozzle employs such a structure that the recessed part is formed in a cylindrical shape with a prescribed depth, a shape of a part of cone whose vertex part is being cut out, or a shape of a part of spherical figure. With this, the entire periphery of the solder ball can be covered by the recessed part that is formed in a cylindrical shape, a shape of apart of cone, or a shape of apart spherical figure. Therefore, positioning accuracy of the solder ball at the time of soldering can be improved further.

Further, the solder nozzle employs such a structure that internal diameter of the recessed part is larger than diameter of the solder ball, and the depth of the recessed part is shorter than the diameter of the solder ball. Specifically, the depth of the recessed part is formed equal to or longer than the radius of the solder ball, and also equal to or shorter than the length that is 90 percent of the diameter of the solder ball.

With this, most part of the solder ball can be housed in the recessed part, so that the solder ball can be held at the tip of the nozzle stably. Further, by having a part of the solder ball extruded from the recessed part to the outer side through not housing the solder ball completely in the nozzle tip part, it becomes possible to have the solder ball directly abutted against each pad at the time of soldering. Therefore, highly reliable soldering can be achieved.

Further, the solder nozzle employs such a structure that: the cross section of the heating beam irradiation hole is formed narrower than the diameter of the solder ball; and an extending hole is formed in a part of periphery of the heating beam irradiation hole at a position on an outer side than circumference of the solder ball that is placed in the recessed part when performing soldering. Furthermore, the extended hole is formed respectively at least in the directions towards which the shift of the solder ball is restricted by the shift restricting device, among the periphery of the heating beam irradiation hole.

With this, the heating beams from the extended holes travel around the circumference of the solder ball, so that the position of the solder ball can be restricted by the air pressure and the like generated by the heating beams. Thereby, in addition to the restriction by the solder recessed part as described above, it is possible to restrict the shift of the solder ball more strictly. As a result, positioning accuracy can be improved still further.

Furthermore, the bonding targets are a bonding pad formed in a magnetic head slider and a bonding pad formed in a suspension to which the magnetic head slider is to be bonded. It is desirable to use the present invention when manufacturing head gimbals assemblies. Moreover, the solder nozzle employs such a structure that the extended hole is formed by corresponding to a position of at least either the bonding pad formed in the magnetic head slider or the bonding pad formed in the suspension, each of which is the bonding target when performing soldering.

This makes it possible to perform soldering of the magnetic head slider that requires a highly precise mounting work, with high reliability and high precision. As a result, the quality of the products manufactured thereby can be improved. Further, through forming the extended hole by corresponding to the position of either one of the bonding pads, the bonding pad that has a low heating rate can be heated effectively. Thus, soldering with still higher reliability can be achieved.

Further, still another aspect of the present invention is a soldering apparatus used for bonding each of bonding pads formed in respective bonding targets with solder. The soldering apparatus comprises: a bonding target placing device for placing each of the bonding targets to a bonding position; and a solder heating device for performing soldering by irradiating a heating beam to a solder ball placed between each of the bonding pads that are formed in respective bonding targets, wherein the solder heating device comprises the above-described solder nozzle.

The present invention is structured in the manner described above, and it functions accordingly. Thereby, shift of the solder ball at the time of soldering can be suppressed effectively with the shift restricting device that is provided in the area that is closer to the tip part than the output end part of the solder nozzle. Therefore, the solder ball can be located at the solder bonding point with high precision at the time of soldering, thereby making it possible to prevent having poor soldering. As a result, it becomes possible to have such excellent effects that the reliability of soldering can be improved and the quality of the products manufactured thereby can be improved.

### BRIEF DESCRIPTION OF THE DRAWINGS

FIG. 1 is a schematic diagram showing an overall structure of a soldering apparatus according to a related technique of the present invention;

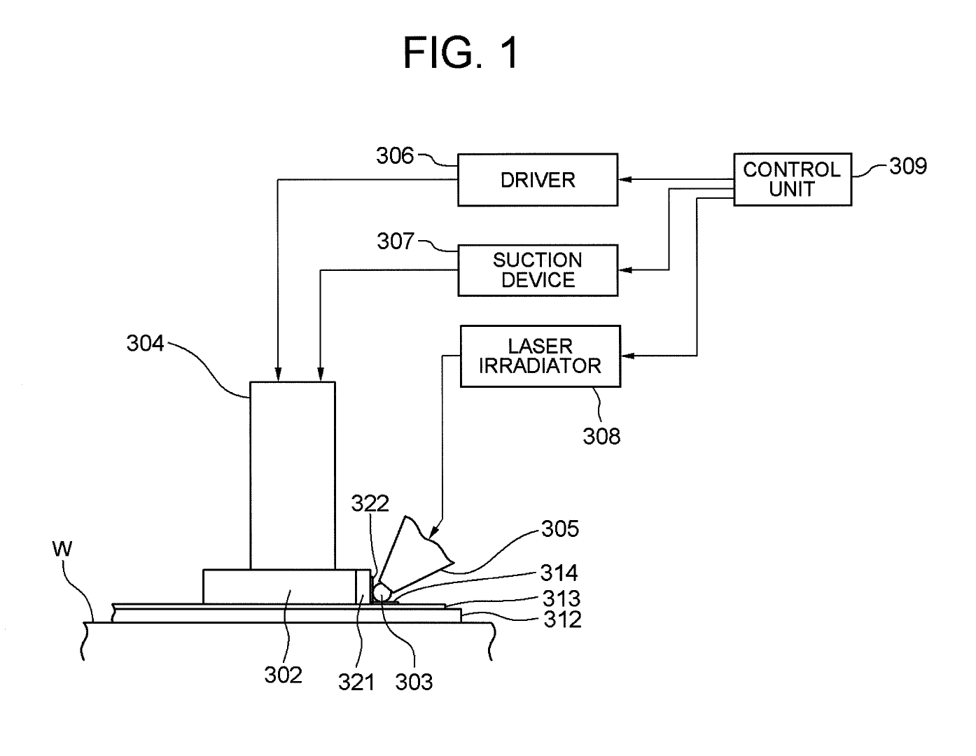

FIG. 2 is a perspective view showing a structure of a laser nozzle according to a related technique of the present invention;

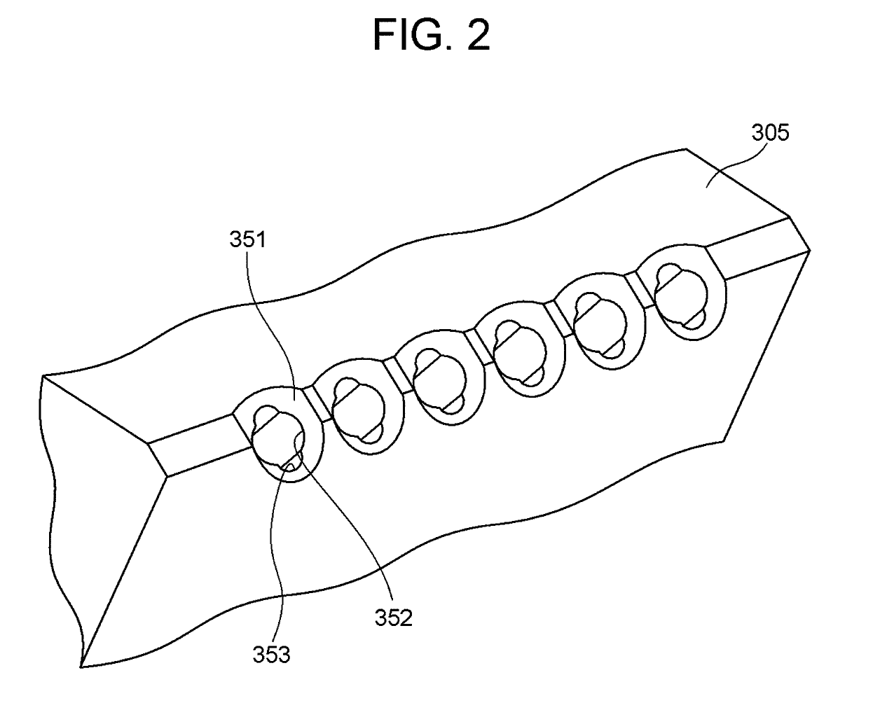

FIG. 3 is a perspective view showing a state where a solder ball is held at the laser nozzle that is disclosed in FIG. 2;

FIG. 4 is a front elevational view of the laser nozzle disclosed in FIG. 2, when viewed from the side;

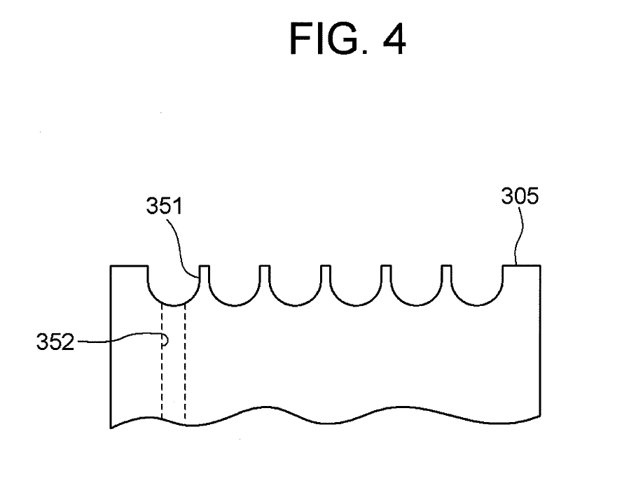

FIG. 5 is a plan view of the laser nozzle disclosed in FIG. 2, when viewed from the above (from the tip side);

FIG. 6 is a sectional view of the laser nozzle shown in FIG. 5, which is taken along the line A-A;

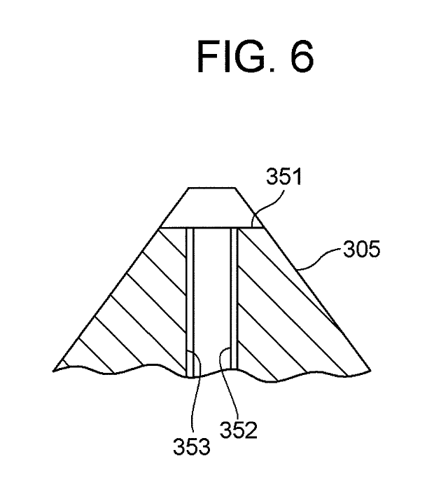

FIG. 7 is an illustration for describing a state of soldering performed by using the laser nozzle that is disclosed in FIG. 2;

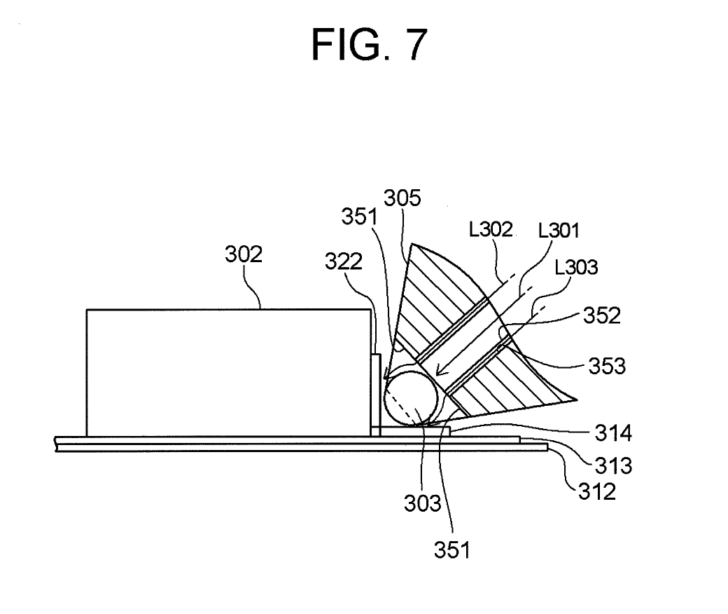

FIG. 8 is an illustration for describing a state of soldering performed by using the laser nozzle that is disclosed in FIG. 2;

FIG. 9 is an illustration showing a structure of a disk device;

FIG. 10 is an illustration showing a structure of a head gimbals assembly that is loaded on the disk device disclosed in FIG. 9;

FIG. 11 is a schematic view showing an overall structure of a soldering apparatus according to a first embodiment;

FIG. 12 is a perspective view showing a structure of a laser nozzle according to the first embodiment that is disclosed in FIG. 11;

FIG. 13 is a perspective view showing a state where a solder ball is held at the laser nozzle of the first embodiment that is disclosed in FIG. 12;

FIG. 14 is a front elevational view of the laser nozzle according to the first embodiment that is disclosed in FIG. 12, when viewed from the side;

FIG. 15 is a plan view of the laser nozzle according to the first embodiment that is disclosed in FIG. 12, when viewed from the above (from the tip side);

FIG. 16 is a sectional view of the laser nozzle shown in FIG. 15, which is taken along the line A-A;

FIG. 17 is an illustration for describing a state of soldering performed by using the laser nozzle of the first embodiment;

FIG. 18 is an illustration for describing a state of soldering performed by using the laser nozzle of the first embodiment;

FIG. 19 is a plan view of the laser nozzle according to a second embodiment, when viewed from the above (from the tip side);

FIG. 20 is an illustration for describing a state of soldering performed by using the laser nozzle of the second embodiment;

FIG. 21 is a plan view of the laser nozzle according to a third embodiment, when viewed from the above (from the tip side);

FIG. 22 is a front elevational view of a laser nozzle according to a fourth embodiment;

FIG. 23 is a side sectional view of the laser nozzle according to the fourth embodiment;

FIG. 24 is a front elevational view of the laser nozzle according to the fourth embodiment; and

FIG. 25 is a side sectional view of the laser nozzle according to the fourth embodiment.

### DETAILED DESCRIPTION OF THE PREFERRED EMBODIMENTS

The feature of the present invention is the shape of a solder nozzle which performs soldering by irradiating a laser beam from its tip part to a solder ball that is placed at a solder boning point. Hereinafter, the structure of a soldering apparatus to which the solder nozzle is mounted and the state of soldering performed thereby will be described in detail by presenting embodiments. The embodiments will be described by referring to a case of manufacturing a head gimbals assembly to be loaded on a disk device, through soldering a magnetic head slider to a suspension. However, it is noted that the soldering nozzle and the soldering apparatus of the present invention can also be utilized to cases where other bonding targets are to be bonded with each other.

### First Embodiment

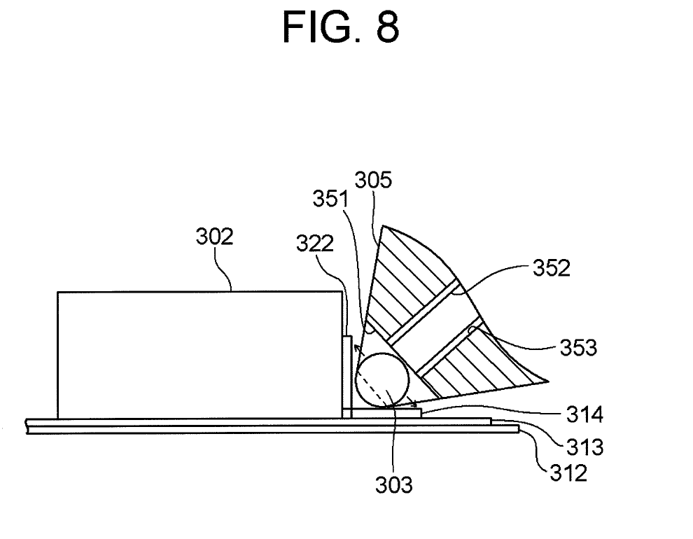

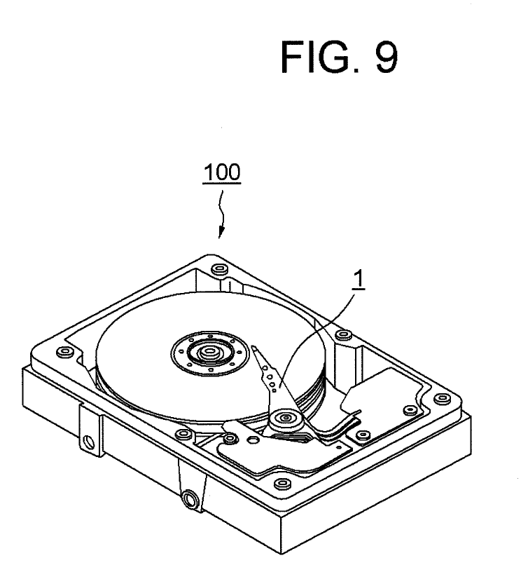

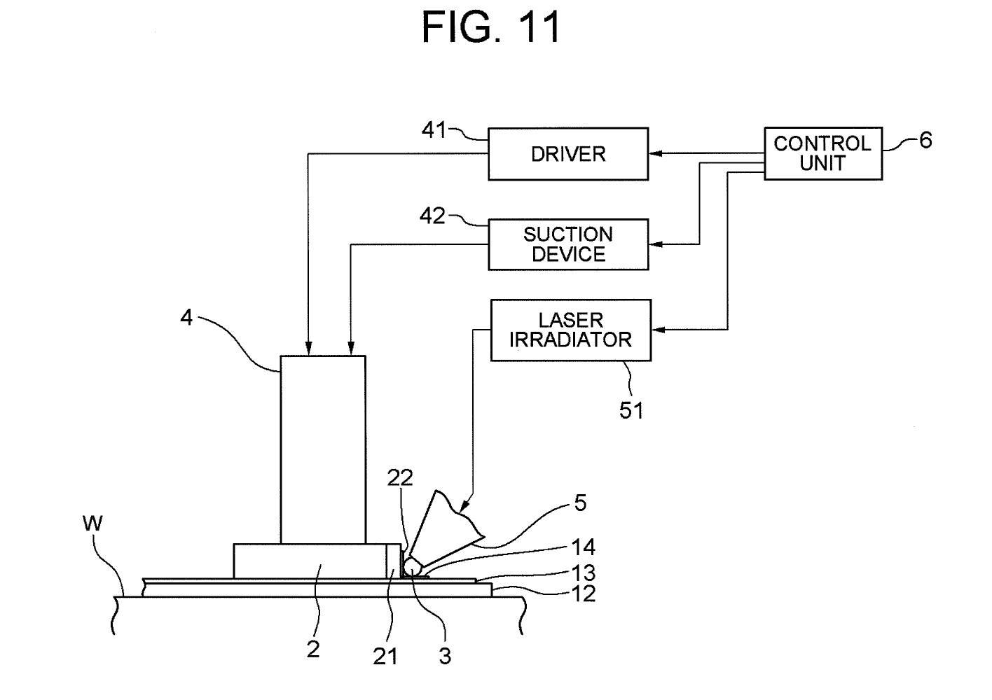

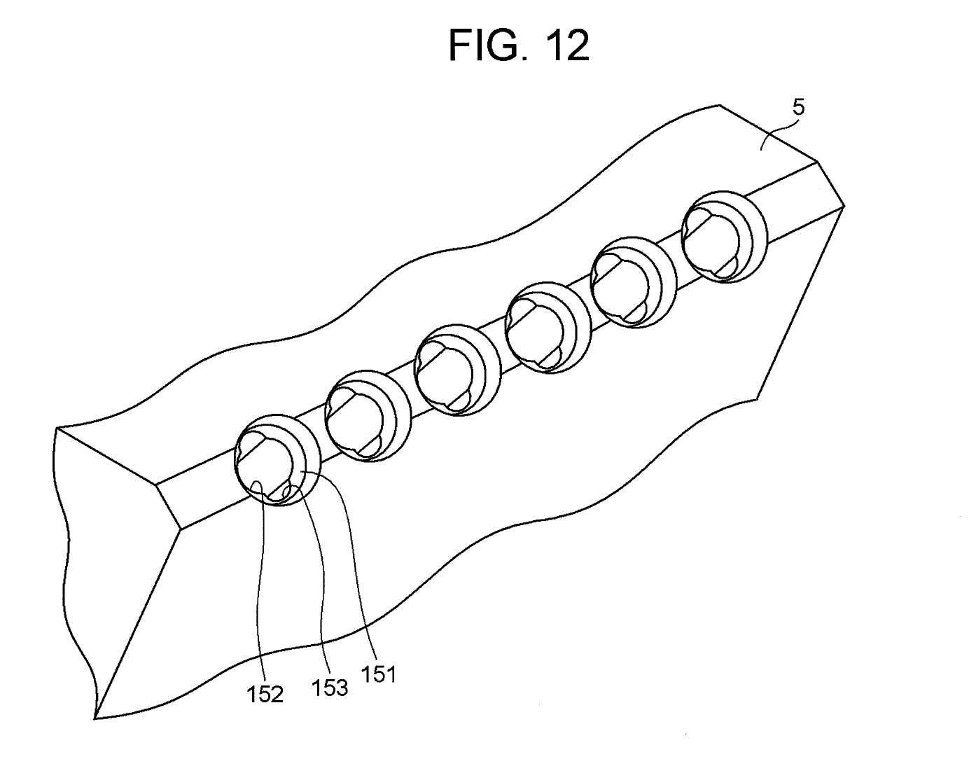

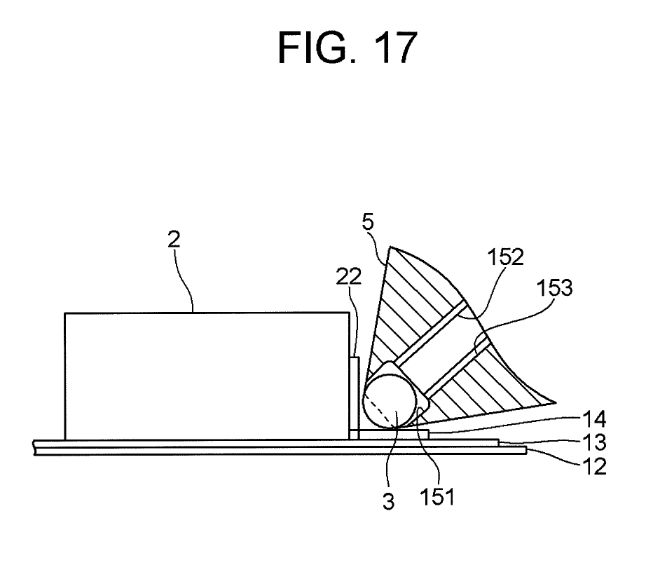

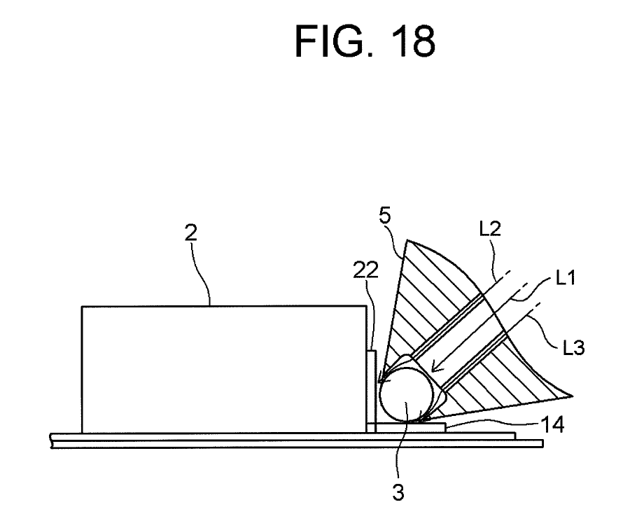

A first embodiment of the present invention will be described by referring to FIG. 9-FIG. 18. FIG. 9 is an illustration for showing a structure of a disk device, and FIG. 8 is an illustration for showing a structure of a head gimbals assembly. FIG. 11 is an illustration showing a structure of the soldering apparatus, and FIG. 12-FIG. 16 are illustrations showing a structure of a laser nozzle. FIG. 17-FIG. 18 are illustrations for describing the state of soldering.

### (Structure)

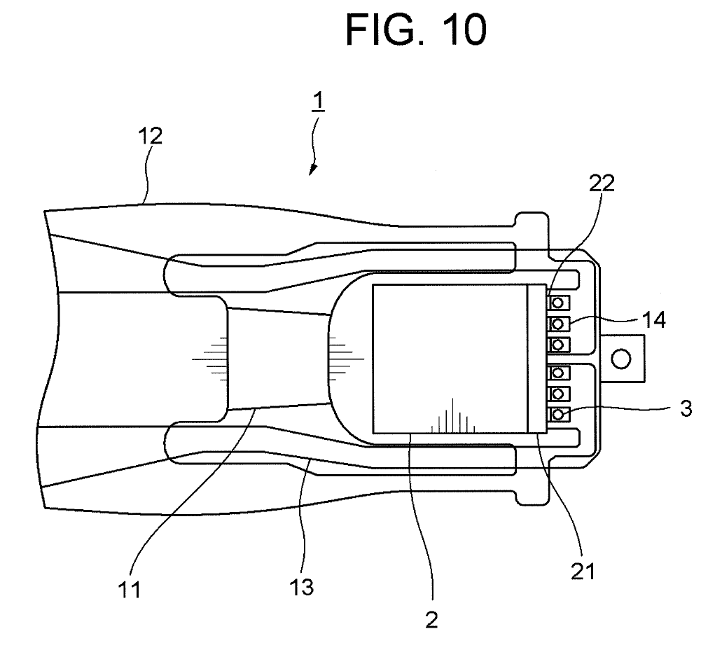

First, the soldering apparatus according to this embodiment is used for manufacturing a head gimbals assembly 1 that is loaded on a disk device 100 as shown in FIG. 9. Specifically, as shown in FIG. 10, it is used for bonding a magnetic head slider 2 to a flexure 12 and a trace 13 which form a suspension that constitutes the head gimbals assembly 1. Now, the structure of the head gimbals assembly 1 will briefly be described by referring to FIG. 10.

The head gimbals assembly 1 comprises: a suspension having a load beam that is connected to a drive arm (not shown); the flexure 12 joined to the load beam 11; and the trace 13 formed as one body on the flexure 12. Further, the head gimbals assembly 1 comprises the magnetic head slider 2 that is loaded on a suspension tongue part formed in the flexure 12. The trace 13 formed as one body on the flexure 12 is a flexible printed board that is obtained by forming a plurality of signal lines on a polyimide layer, and six bonding pads 14 to be connecting terminals connected to the signal lines are formed on one end side thereof to which the magnetic head slider 2 is loaded. The bonding pads 14 formed on the trace 13 will be referred to as suspension-side pads 14 hereinafter. Further, the magnetic head slider 2 comprises a magnetic head element 21 on one end thereof for performing recording and reproduction of data to/from a disk. Six bonding pads 22 to be input/output terminals of the magnetic head element 21 are formed on the end face of the magnetic head element 21. The bonding pads 22 formed on the magnetic head element 21 (magnetic head slider 2) will be referred to as slider-side pads 22 hereinafter.

The magnetic head slider 2 and the suspension where the trace 13 and the flexure 12 are unified, which constitute the above-described head gimbals assembly, are the targets of soldering, i.e. bonding targets. Specifically, the slider-side pads 22 formed on the magnetic head element 21 of the magnetic head slider 2 and the suspension-side pads 14 formed on the trace 13 are to be solder-bonded. The head gimbals assembly 1 according to this embodiment has six solder bonding points between the slider-side pads 22 and the suspension-side pads 14 as pairs.

Next, FIG. 11 shows a structure of a soldering apparatus according to this embodiment, which is used when manufacturing the head gimbals assembly 1 by solder-bonding the magnetic head slider 2 to the trace 13 (flexure 12), which are the bonding targets described above.

As shown in FIG. 11, the soldering apparatus comprises a support stand W (bonding target placing device) for supporting the flexure 12 that constitutes the suspension on which the trace 13 is unified. Further, the soldering apparatus comprises a transporting nozzle 4 (bonding target placing device, transporting device) which holds, with its tip part, the magnetic head slider 2 that is to be bonded to the flexure 12, and transports and places it at a bonding position on the flexure 12. A driver 41 (bonding target placing device) is connected to the transporting nozzle 4, and the position of the nozzle is drive-controlled by the driver 41 so that the magnetic head slider 2 that is held at the tip part of the nozzle can be transported. Further, a suction device 42 is connected to the transporting nozzle 4, and the tip part of the transporting nozzle 4 is formed substantially in a cylindrical shape. A sucking force is generated by sucking the air from the tip side (lower end side) towards the inner side (upper side). The transporting nozzle 4 holds the magnetic head slider 2 at its tip part by sucking the magnetic head slider 2 towards the upper side by the sucking force.

Further, the soldering apparatus comprises: a laser nozzle 5 (solder nozzle) from which a laser beam (heating beam) for heating the solder 3 at the solder bonding point is irradiated; and a laser irradiator 51 for outputting the laser beam from the laser nozzle 5 (solder heating device). A driver and a suction device, not shown, are connected to the laser nozzle 5, thereby making it possible to irradiate the laser beam to the solder ball 3 while holding the solder ball 3 at the tip part of the nozzle 5 and placing the solder ball 3 at the solder bonding point that is between the slider-side pad 22 and the suspension-side pad 14. Further, as will be described in detail later, the laser nozzle 5 of this embodiment is structured to be able to hold six solder balls 3 by corresponding to each of the pads 22 and 24 located at six points on the tip part side (right side) of the head gimbals assembly 1 that is shown in FIG. 10, and to be able to irradiate the laser beams simultaneously to the six solder balls 3, i.e. to the six solder bonding points. The solder balls 3 may be placed at the solder bonding points by other devices.

Furthermore, the soldering apparatus comprises a control unit 6 for controlling the actions of the entire apparatus, i.e. actions of the driver 41, the suction device 42, and the soldering laser irradiator 51. The control unit 6 is constituted with a computer having an arithmetic unit and a storage unit. Prescribed programs are installed to the arithmetic unit of the control unit 6, thereby constituting a slider transportation control part and a laser control part.

The slider transportation control part controls the actions of the driver 41 and the suction device 42 described above to transport the magnetic head slider 2 to the solder bonding position. Specifically, first, the suction device 42 is controlled to generate a sucking force to the transporting nozzle 4 to hold the magnetic head slider 2 at the tip part thereof, and the driver 41 is controlled in this state to move the transporting nozzle 4 to transport the magnetic head slider 2 onto the tongue part of the flexure 12.

Further, the laser control part controls the actions of the driver and the suction device, not shown, of the laser nozzle 5 to perform drive-controls regarding the position of the laser nozzle 5 and sucking/holding controls of the solder ball 3 to the tip part of the laser nozzle 5. Then, the tip part of the laser nozzle 5 is moved to the solder bonding point that is between each of the pads 22 and 14. Thereafter, the action of the laser irradiator 51 is controlled to irradiate a laser beam from the laser nozzle 5 to the solder ball 3 held at the tip. With this, the solder ball 3 is fused, and each of the pads 22 and 14 are soldered to each other.

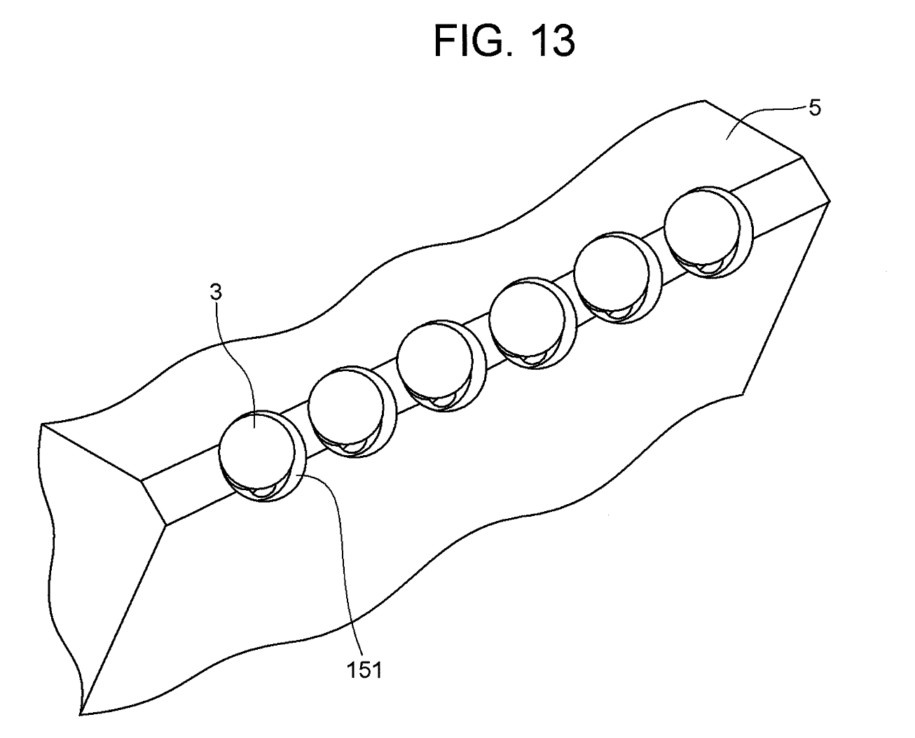

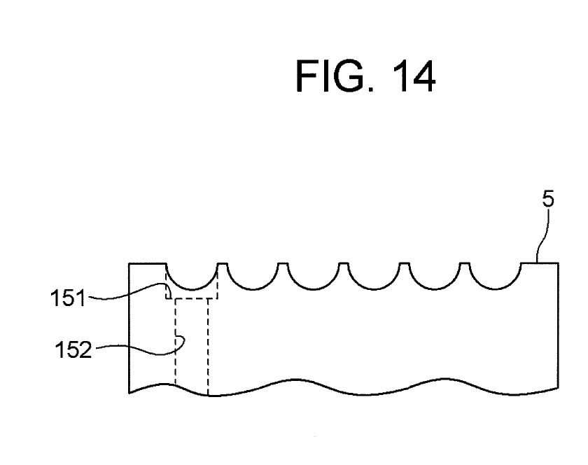

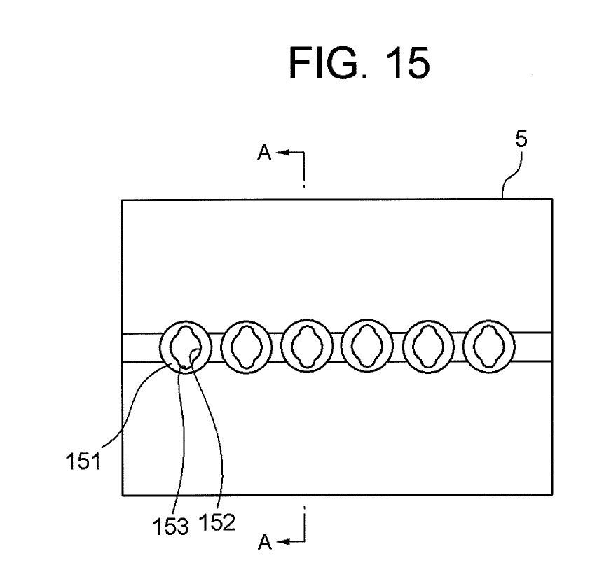

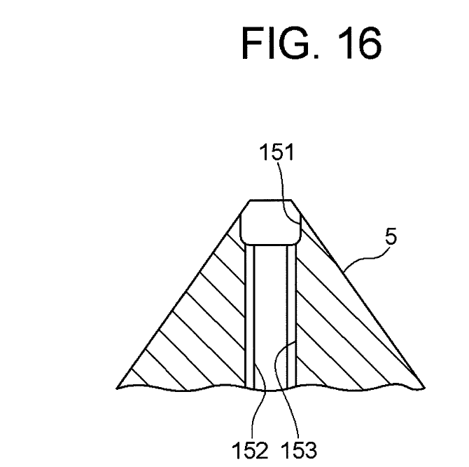

Next, the structure of the laser nozzle 5 according to this embodiment will be described by referring to FIG. 12-FIG. 16. FIG. 12 is a perspective view showing the tip part of the laser nozzle 5, and FIG. 13 is an illustration showing the state where the solder balls 3 are loaded to the laser nozzle 5. Further, FIG. 14 is an illustration of the laser nozzle 5 viewed from the side, and FIG. 15 is an illustration of the laser nozzle 5 viewed from the tip side. FIG. 16 is a sectional view of the laser nozzle 5 taken along the line A-A of FIG. 15.

As shown in those illustrations, first, the laser nozzle 5 is formed in a mountain-like shape (wedged shape) having a prescribed-width sharp tip part, which is formed with two inclined plane meeting at a right angle. The ridgeline part that is the tip part is chamfered (see sectional view of FIG. 16). Further, six solder recessed parts 151 (recessed parts) corresponding to six solder bonding points between each of the pads 22, 14 are formed in the chamfered part along the ridgeline (see FIG. 12 and FIG. 15). As shown in FIG. 14, FIG. 15, and FIG. 16, each of the solder recessed part 151 is a cylindrical-shaped recessed part that is craved from the tip side towards the inner side until reaching a prescribed depth. The diameter (inside diameter) of the cylindrical-shaped solder recessed part 151 is larger than that of the solder ball 3. For example, it is formed to be larger than the diameter of the solder ball 3 by a range of about 5 μm to 15 μm. Further, the depth of the solder recessed part 151 is formed to be shorter than the diameter of the solder ball 3. For example, the solder recessed part is formed to have the depth that is equal to or longer than the radius of the solder ball 3, and also equal to or shorter than length that is 90 percent of the diameter of the solder ball.

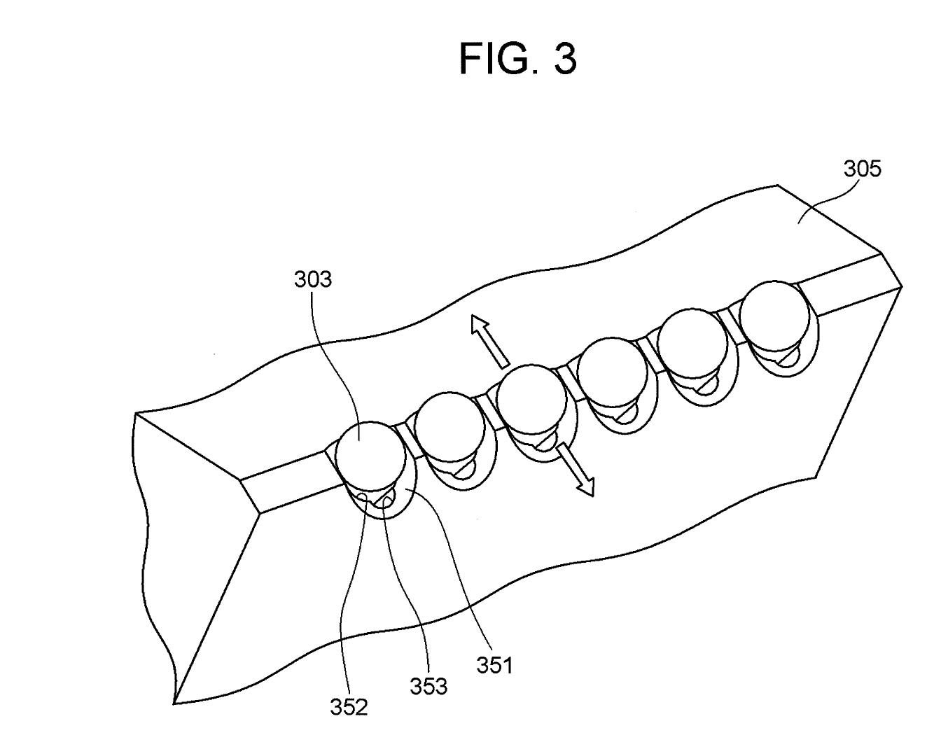

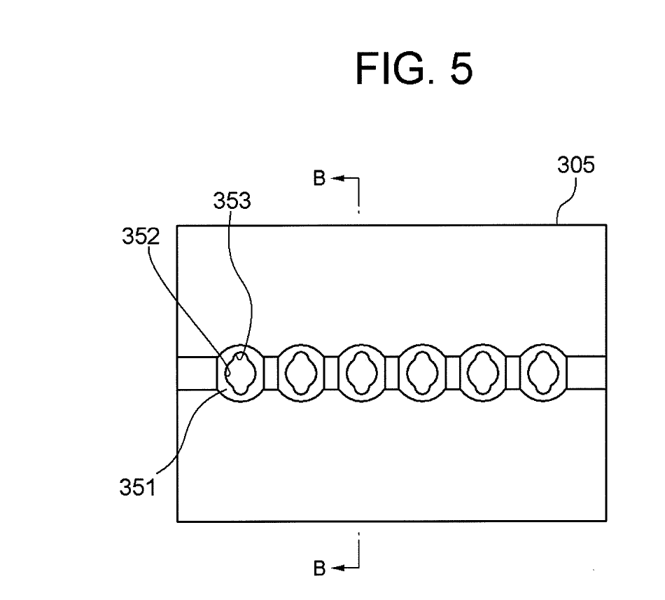

By forming the solder recessed part in the above-described shape, most part of the solder ball 3 is housed within the solder recessed part 151 at the time of soldering, as shown in FIG. 17 that will be described later. With this, as shown in FIG. 5, the periphery of the solder ball 3 housed within the solder recessed part 151 comes to be surrounded by inner wall faces (shift restricting device) of the solder recessed part 15. Thus, shift of the solder ball 3 is restricted by the inner wall faces. Specifically, regarding the peripheral space of the solder ball 3, the arranged array direction (ridgeline direction) of the solder recessed parts 151 side thereof is surrounded by partition walls that exist between a solder recessed part and other solder recessed parts neighboring to that recessed part. Further, unlike the case of the conventional technique described above, the solder ball 3 is also surrounded by the inner fall faces of the formed solder recessed parts 151 in the direction that is perpendicular to the arranged array direction of the solder recessed parts 151 (inclined plane side). Therefore, shift of the solder ball 3 in the directions of the inclined planes of the laser nozzle 5, i.e. in the directions of arrows shown in FIG. 3 that is described above, can also be restricted.

Further, tubular laser irradiation holes 152, 153 (heating beam irradiation holes), through which laser beams L1, L2, and L3 outputted from the above-described laser irradiator 51 are guided, are formed in the inner bottom face of the solder recessed part 151. In other words, the above-described solder recessed part 151 is formed in the area that is closer to the tip side than the heating beam output end part of the laser irradiation holes 152, 153. Regarding the sectional view of the laser irradiation holes 152, 153, as can be seen from FIG. 15, it is constituted with a circular center hole 152 that is smaller than the diameter of the solder ball 3 and two semicircular extended holes 353 formed at the top and bottom in the periphery of the center circle, i.e. on each inclined plane side. Specifically, the extended hole 153 is formed in such a manner that a part thereof comes on the outer side of the circumference of the solder ball 3, when the solder ball 3 is placed into the solder recessed part 151. That is, the laser irradiation holes 152, 153 are formed to have a narrow width in the arranged array direction (ridgeline direction) of the solder recessed parts 151 and to have a wide width in the direction that is perpendicular to the arranged array direction.

### (Operations)

Next, operations of the soldering apparatus having the above-described structure, i.e. operations of a soldering method according to the present invention, will be described by referring to illustrations of FIG. 17-FIG. 18 which show the state at the time of soldering.

First, the magnetic head slider 2 is sucked and held at the tip part of the transporting nozzle 4, and it is transported onto the flexure 12 that is loaded on the support stand W. At this time, the magnetic head slider 2 is loaded on the tongue part of the flexure 12 in such a manner that the slider-side pad 22 of the magnetic head slider 2 and the suspension-side pad 14 formed in the trace 13 on the flexure 12 are arranged at almost right angles to each other.

Subsequently, the solder ball 3 is sucked and held at the tip part of the laser nozzle 5, i.e. held in the solder recessed part 151, and the laser nozzle 5 is moved to the solder bonding point. Then, as shown in FIG. 17, the laser nozzle 5 is located in such a manner that the solder ball 3 comes between the slider-side pad 22 and the suspension-side pad 14. At this time, the solder ball 3 remains to be housed in the solder recessed part 151.

Thereafter, as shown in FIG. 18, the action of the laser irradiator 51 is controlled to irradiate the laser beams L1, L2, and L3 from the laser nozzle 5. Upon this, the laser beam L1 passing through the center hole 152 part of the laser irradiation holes 152, 153 is irradiated to the solder ball 3 to heat the solder ball 3. In the meantime, the laser beams L2 and L3 passing through the extended hole 153 parts are irradiated along the circumference of the solder ball 3, thereby heating the solder ball 3 as well as the slider-side pad 22 and the suspension-side pad 14 at the same time. Further, the laser gasses outputted from the extended holes 153 along with the laser beams L2 and L3 also pass around the circumference of the solder ball 3, thereby working to restrict the shift of the solder ball 3 in the directions of each pad.

At this time, in this embodiment, most part of the solder ball is housed inside the solder recessed part 151 and the periphery thereof is mostly surrounded by the wall faces. Thus, even if there is a force generated to shift the solder ball 3 by the influence of the outputted laser gasses, the shift of the solder ball 3 is restricted by the inner wall faces of the solder recessed part 151. Especially, the wall faces on inclined plane sides of the nozzle are formed in this embodiment while there is no such wall face formed in the laser nozzle 305 of the conventional technique that is described above. Therefore, it is possible to effectively suppress the shift of the solder ball 3 at least to the arranged array direction of the solder recessed part 151 (ridgeline direction) and to the direction perpendicular to the arranged array direction (i.e. shift to two directions crossing with each other).

As described above, shift of the solder ball 3 can be suppressed effectively at the time of soldering by using the laser nozzle 5 that is formed in the above-described shape. Therefore, the solder ball 3 can be located at the solder bonding point with high precision at the time of soldering. This makes it possible to prevent having poor soldering, e.g. to suppress such a case that only one of the pads (the slider-side pad 22 or the suspension-side pad 14) is soldered, so that the reliability of soldering can be improved.

Especially, this embodiment comprises the substantially cylindrical-shaped solder recessed parts 151 formed by corresponding to the shape of the spherical solder ball 3, as a device for restricting the shift of the solder ball 3. Therefore, shift of the solder ball 3 can be restricted in all the directions, so that the solder ball 3 can be located with still higher precision. Thus, it is preferably used for manufacturing the head gimbals assemblies 1 and the like, which require high precision and high reliability.

Note here that the device for restricting the shift of the solder ball 3 is not limited to be in the above-described shape, i.e. the recessed shape. For example, the device may be formed in any shapes as long as it is capable of restricting the shift in two directions that are orthogonal to each other, such as in the arranged array direction of the solder recessed parts 151 and the direction perpendicular to that direction. For example, protrusions or the like may be provided at the tip part of the laser nozzle 5 to be located around the solder ball 3 as in the above-described case for functioning as a member to restrict the shift of the solder ball 3.

In the above, it has been described bay referring to the case of soldering the slider-side pad 22 formed on the magnetic head element side of the magnetic head slider 2. However, the present invention may also be used for soldering the bonding pad formed on the end face that is on the opposite side from the magnetic head element 21 to the suspension (flexure 12) for fixing the magnetic head slider 2 to the suspension (flexure 12). Further, the present invention is not limited to be used only for soldering the magnetic head slider 2 to the suspension, but it can also be utilized for other soldering cases.

Furthermore, in the above, there has been described the laser nozzle 5 having a plurality of laser irradiation holes 152, 153 formed to be able to irradiate laser beams to a plurality of solder balls 3 simultaneously. The number of the laser irradiation holes 152, 153 formed in a single laser nozzle 5 can be determined arbitrarily. That is, the laser nozzle 5 may have a single set of laser irradiation holes 152, 153 and a single solder recessed part 151.

Further, while it has been described in the above by referring to the case of performing soldering by irradiating the laser beams L1, L2, and L3 to the solder ball 3 to fuse the solder thereby, other heating beams than the laser beams may be irradiated to perform soldering.

### Second Embodiment

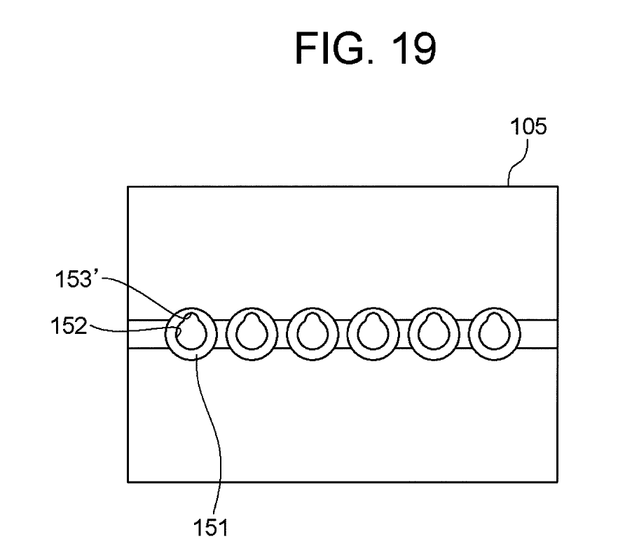

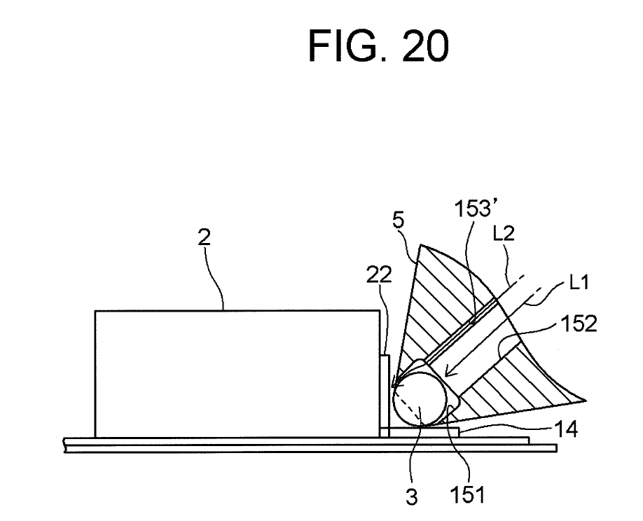

Next, a second embodiment of the present invention will be described by referring to FIG. 19-FIG. 20. A soldering apparatus according to this embodiment has basically the same structures as those of the first embodiment described above, except that the shape of a laser nozzle 105, particularly the shape of the laser irradiation hole, is different.

Specifically, as shown in the illustration of FIG. 19 showing the view of the laser nozzle 105 from the tip side, a substantially circular-shaped extended hole 153′ is formed only in one section of the circumference of a center hole 152, which constitute the laser irradiation holes 152, 153′ from which laser beams are let through and outputted. As shown in FIG. 20, this extended hole 153′ is formed at a position to correspond to the slider-side pad 22 when the laser nozzle 105 is placed at a solder bonding point. Thus, the laser beam L2 passing through the extended hole 153′ travels along the circumference of the solder ball 3 and works to heat only the slider-side pad 22. Thereby, the slider-side pad 22 having a low temperature increase rate can be heated while the solder ball 3 is heated by the laser beam L1 that is outputted from the center hole 152 of the laser irradiation holes. Therefore, highly reliable soldering can be achieved when the solder ball 3 is fused.

As described above, the magnetic head slider 2 has a large volume. In addition, the transporting nozzle 4 is in contact with the magnetic head slider 2 at the time of soldering and, at the same time, a sucking force is applied to the magnetic head slider 2. Under such condition, it is highly possible that the heat radiation rate near the slider-side pad 22 of the magnetic head slider 2 becomes high so that the temperature increase rate thereat becomes low. Therefore, it is desirable to apply a lot of heat to the slider-side pad 22.

### Third Embodiment

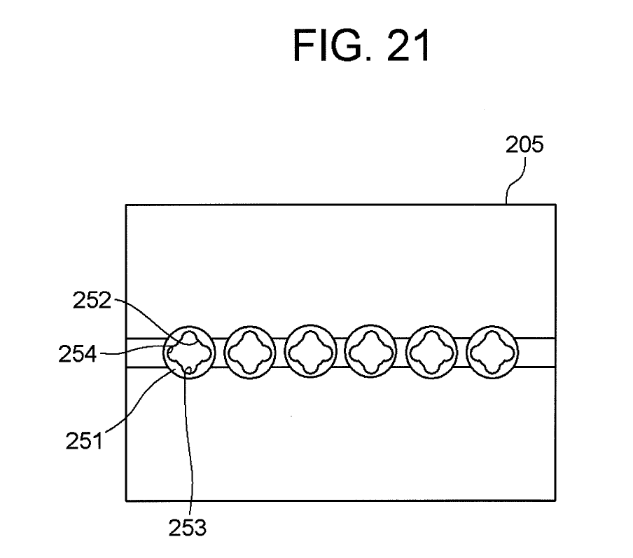

Next, a third embodiment of the present invention will be described by referring to FIG. 21. A soldering apparatus according to this embodiment has basically the same structures as those of the first embodiment described above, except that the shape of a laser nozzle 205, particularly the shape of the laser irradiation hole, is different.

As shown in the illustration of FIG. 21 showing the view of the laser nozzle 205 from the tip side, the laser nozzle 205 has extended holes 253, 254 formed in four sections on the circumference of a center hole 122 of laser irradiation holes from which laser beams are let through and outputted. Specifically, a pair of substantially circular-shaped extended holes 254 is formed in the arranged array direction of solder recessed parts 251 on the circumference of the circular-shaped center hole 252, and a pair of extended holes 253 is formed in a direction perpendicular to the arranged array direction. That is, in addition to the laser irradiation holes 152, 153 described in the first embodiment (see FIG. 15), the extended holes are formed additionally in the arranged array direction (ridgeline direction) of the solder recessed parts 151.

With this, the laser beams, i.e. the laser gasses, outputted from the extended holes 253 and 254 pass the four sections on the circumference of the solder ball 3, so that the position of the solder ball 3 can be restricted by the air pressure and the like of the laser gasses. Thereby, in addition to the restriction by the solder recessed part 251 as described above, it is possible to restrict the shift of the solder ball 3 more strictly. As a result, positioning accuracy can be improved still further.

### Fourth Embodiment

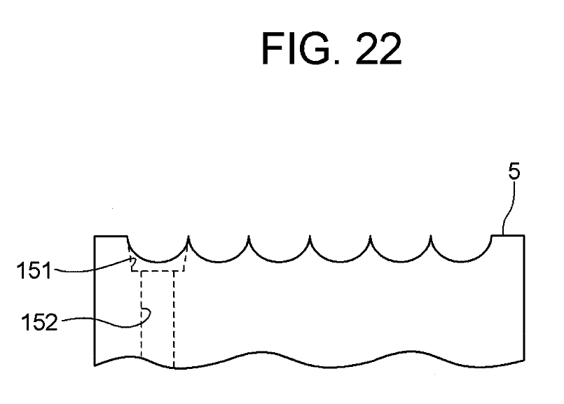

Next, a fourth embodiment of the present invention will be described by referring to FIG. 22-FIG. 25. A soldering apparatus according to this embodiment has basically the same structures as those of the first embodiment described above, except that the shape of a laser nozzle 205, particularly the shape of a solder recessed part 151 formed on its tip side, is different.

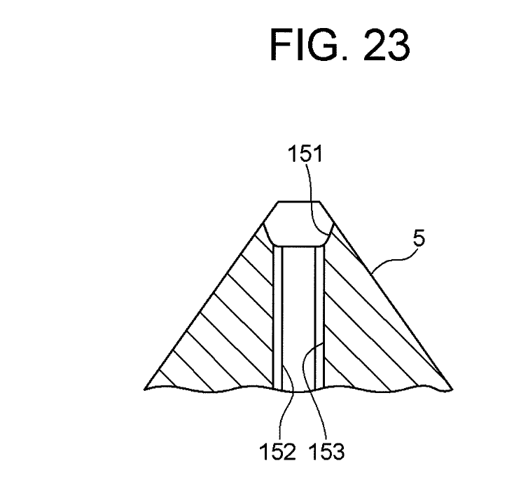

In the case shown in FIG. 22 and FIG. 23, the solder recessed part 151 is formed in a shape of a part of cone whose vertex part is being cut out. In other words, the side wall of the above-described cylindrical shape is formed by sloping to expand towards the opening side. Note here that the diameter (inner diameter) of the opening part of the solder recessed part 151 is larger than the diameter of the solder ball 3. Further, the depth of the solder recessed part 151 is formed to be shorter than the diameter of the solder ball 3. For example, it is formed to have a depth that is equal to or larger than the radius of the solder ball 3 and equal to or shorter than the length that is 90 percent of the diameter of the solder ball.

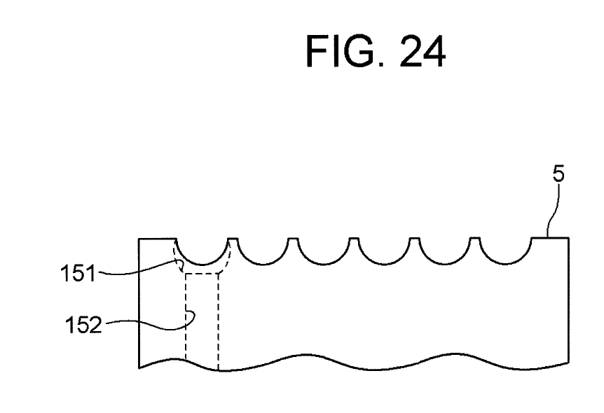

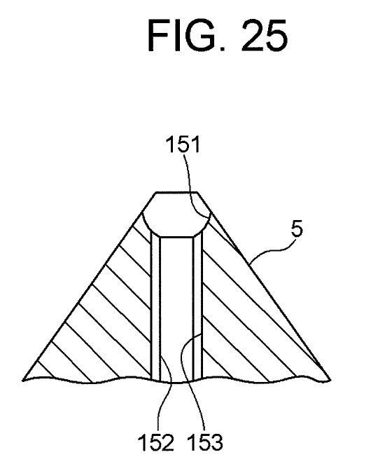

Furthermore, in the case shown in FIG. 24 and FIG. 25, the solder recessed part 151 is formed in a shape of a part of spherical figure. In other words, the side wall of the above-described cylindrical shape is formed in a curved face to expand gradually towards the opening side. For example, the side wall of the solder recessed part 151 is formed in a hemispherical shape. Note here that the diameter (inner diameter) of the opening part of the solder recessed part 151 is larger than the diameter of the solder ball 3. Further, the depth of the solder recessed part 151 is formed to be shorter than the diameter of the solder ball 3. For example, it is formed to have a depth that is equal to or larger than the radius of the solder ball 3 and equal to or shorter than the length that is 90 percent of the diameter of the solder ball. However, the shapes of the solder recessed part 151 described above are illustrated merely as a way of examples, and it is not intended to be limited to the above-described shapes.

By forming the solder recessed part 151 in the above-described shapes, most part of the solder ball 3 can be housed within the solder recessed part 151 at the time of soldering. With this, the solder ball 3 housed within the solder recessed part 151 is in a state of being surrounded by the inner wall face of the solder recessed part 151, so that shift of the solder ball 3 can be restricted by that inner wall face. As a result, stable soldering can be achieved.

The soldering nozzle and the soldering apparatus according to the present invention can be used for soldering electronic components, such as when soldering a magnetic head slider to a suspension. In that respect, the present invention has industrial applicability.

What is claimed is:

1. A solder nozzle having a heating beam irradiation hole formed therein for irradiating a heating beam to a solder ball placed between each of bonding pads formed in respective bonding targets, said solder nozzle comprising,
in an area that is closer to its tip side than a heating beam output end part of said heating beam irradiation hole, a shift restricting device for restricting shift of said solder ball, to which said heating beam is irradiated, at least in two directions that are orthogonal to each other.

2. A solder nozzle having a plurality of heating beam irradiation holes formed therein in an array for irradiating heating beams, respectively, to a plurality of solder balls placed between each of bonding pads formed in respective bonding targets, said solder nozzle comprising,
in an area that is closer to its tip side than a heating beam output end part of each of said heating beam irradiation holes, a shift restricting device for restricting shift of said solder ball at least in an arranged direction of said plurality of heating beam irradiation holes and in a direction perpendicular to said arranged array direction.

3. The solder nozzle according to claim 1, wherein:
a recessed part having a wider cross section than that of said laser irradiation hole, which is capable of housing a part of said solder ball, is formed in an area that is closer to its tip side than a heating beam output end part; and
said shift restricting device is formed with inner wall faces of said recessed part.

4. The solder nozzle according to claim 3, wherein said recessed part is formed in a cylindrical shape with a prescribed depth, a shape of a part of cone whose vertex part is being cut out, or a shape of a part of spherical figure.

5. The solder nozzle according to claim 4, wherein internal diameter of said recessed part is larger than diameter of said solder ball.

6. The solder nozzle according to claim 4, wherein said depth of said recessed part is shorter than said diameter of said solder ball.

7. The solder nozzle according to claim 6, wherein said depth of said recessed part is equal to or longer than radius of said solder ball, and also equal to or shorter than length that is 90 percent of said diameter of said solder ball.

8. The solder nozzle according to claim 4, wherein:
said cross section of said heating beam irradiation hole is formed narrower than said diameter of said solder ball; and an extending hole is formed in a part of periphery of said heating beam irradiation hole at a position on an outer side than circumference of said solder ball that is placed in said recessed part when performing soldering.

9. The solder nozzle according to claim 8, wherein said extended hole is formed respectively at least in said directions towards which said shift of said solder ball is restricted by said shift restricting device, among said periphery of said heating beam irradiation hole.

10. The solder nozzle according to claim 1, wherein said bonding targets are a bonding pad formed in a magnetic head slider and a bonding pad formed in a suspension to which said magnetic head slider is to be bonded.

11. The solder nozzle according to claim 8, wherein:
said bonding targets are a bonding pad formed in a magnetic head slider and a bonding pad formed in a suspension to which said magnetic head slider is to be bonded; and
said extended hole is formed by corresponding to a position of at least either said bonding pad formed in said magnetic head slider or said bonding pad formed in said suspension, each of which is said bonding target when performing soldering.

12. A soldering apparatus used for bonding each of bonding pads formed in respective bonding targets with solder, comprising:
a bonding target placing device for placing each of said bonding targets to a bonding position; and
a solder heating device for performing soldering by irradiating a heating beam to a solder ball placed between each of said bonding pads that are formed in respective bonding targets, wherein
said solder heating device comprises a solder nozzle having a heating beam irradiation hole formed therein for irradiating a heating beam to a solder ball placed between each of bonding pads formed in respective bonding targets, said solder nozzle comprising, in an area that is closer to its tip side than a heating beam output end part of said heating beam irradiation hole, a shift restricting device for restricting shift of said solder ball, to which said heating beam is irradiated, at least in two directions that are orthogonal to each other.
